(19) United States
(12) Patent Application Publication
(10) Pub. No.: US 2010/0082989 A1
(43) Pub. Date: Apr. 1, 2010

(54) Storing Composite Services on Untrusted Hosts

(75) Inventors: Laurent Bussard, Aachen (DE); Ulrich Pinsdorf, Herzogenrath (DE); Anna Nano, Nordrhein-Westfalen (DE); Joris Claessens, Heverlee (BE); Christian Geuer-Pollmann, Dusseldorf (DE)

Correspondence Address: LEE & HAYES, PLLC, 601 W. RIVERSIDE AVENUE, SUITE 1400, SPOKANE, WA, 99201, US

(73) Assignee: Microsoft Corporation, Redmond, WA (US)

(21) Appl. No.: 12/238,917

(22) Filed: Sep. 26, 2008

(51) Int. Cl. H04L 9/32; G06F 21/00; H04L 9/08

(52) U.S. Cl. 713/176; 726/8; 713/168; 380/278

(57) ABSTRACT

A method of storing a composite service on an untrusted host without enabling the untrusted host to access resources called by the composite service is described. In an embodiment, the delegator provides a delegatee with credentials to enable verification of the composite service and to enable access to the resources. The credential which is provided to enable access to the resources may be a credential which can be used to decrypt access credentials for each of the resources. These access credentials are stored in encrypted form in a credential store. The delegatee downloads the composite service and the encrypted access credentials and executes the composite service once it has been verified.

### BACKGROUND

There are currently two ways in which a user can access software to handle data: the user can either use applications which are executed in their local computer or they can use remote services, where the application runs on a remote computer. Use of a remote service does not require the user to obtain special software, however, locally run applications are generally considered to provide advantages in security and trust.

Where a remote service is used, the service may be a composite service. A composite service is a service which is built upon resources (such as other services) such that when the composite service runs, it calls those resources. Examples of resources include a web service, a web page, a file sharing service, a database, a data object in a storage system etc. If access to the resources (e.g. to the other services) is protected in some manner, the composite service requires access rights to enable the composite service to call those resources.

The embodiments described below are not limited to implementations which solve any or all of the disadvantages of known methods of service provision.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

A method of storing a composite service on an untrusted host without enabling the untrusted host to access resources called by the composite service is described. In an embodiment, the delegator provides a delegatee with credentials to enable verification of the composite service and to enable access to the resources. The credential which is provided to enable access to the resources may be a credential which can be used to decrypt access credentials for each of the resources. These access credentials are stored in encrypted form in a credential store. The delegatee downloads the composite service and the encrypted access credentials and executes the composite service once it has been verified.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is a schematic diagram of a delegation system;

FIG. 2 shows a flow diagram of an example method of operation of a delegation system;

FIGS. 3-8 show diagrams of an example method of delegation;

FIGS. 9-11 show diagrams of further example methods of delegation in which the composite service is encrypted;

FIGS. 12-13 show diagrams of further example methods of delegation which have increased resilience to dictionary attacks;

FIGS. 14-16 show diagrams of further example methods of delegation in which the services are untrusted;

FIGS. 17-18 show an example implementation of a method of delegation;

FIG. 19 shows two examples of a schematic architecture for use in the methods described herein; and

FIG. 20 illustrates an exemplary computing-based device in which embodiments of the delegation methods described herein may be implemented.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

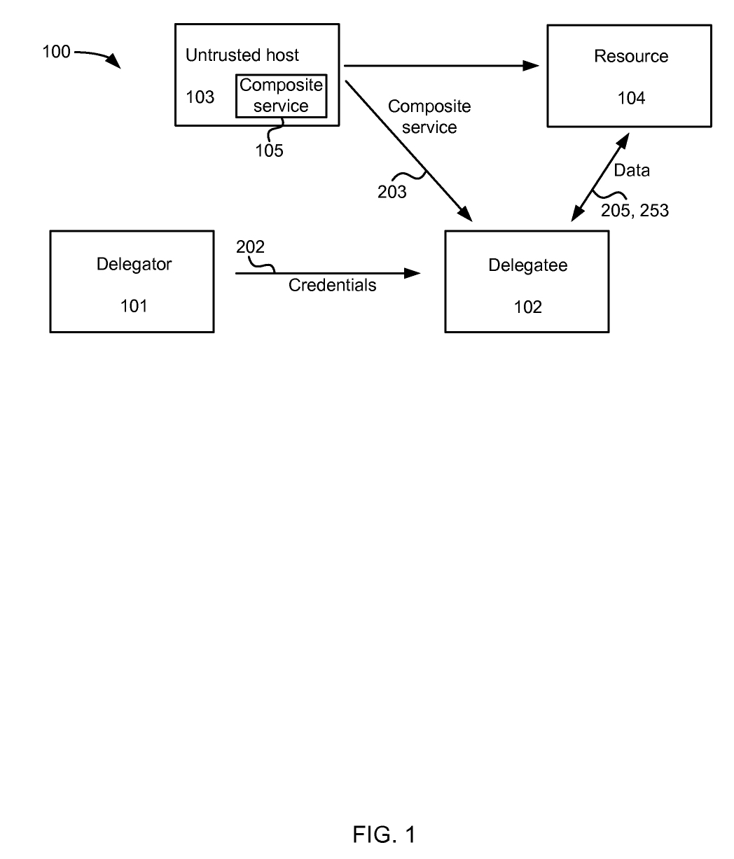

FIG. 1 is a schematic diagram of a delegation system 100 which comprises a delegator 101, a delegatee 102, a host 103 and a resource (or service) 104. In such a delegation system, the resource 104 is ‘owned’ by the delegator 101 such that the delegator 101 can grant access rights to the resource (and does not necessarily host the resource), e.g. to the delegatee 102. In the example of an online picture service that hosts users' digital photo collections, a user does not own the online picture service as such, but does own the user's own photo collection at this service. The delegatee 102 is a user of a composite service or mash-up 105 stored on the host 103 and which calls on the resource 104. The host 103 may be an untrusted host, e.g. a host which is unknown and which may not be trusted not to collect the data provided by the resource, or a distrusted host, e.g. a host which is not trusted.

The term ‘mash-up’ is used herein to refer to a client-side composite service which may make use of multiple resources. In an example, the mash-up may be an application (e.g. a web application) that combines data from more than one source into a single logical application (which comprises distributed resources). The sources of data may be web services or other resources. Composite services (including mash-ups) may make use of application programming interfaces (APIs) published by many service providers and which may be based on web standards. These APIs allow the functionality of services to be used. Depending on the technology used for creating composite services, they can be executed in the browser on the client-side or on the server-side. Composite services may be used to access services provided by other entities (e.g. other enterprises, which may provide the resources for free or may charge for their use) or may be used within enterprises. Composite services (and mash-ups) are used herein by way of example and the methods and systems described herein may be used for any mobile software code which may be downloaded and executed on the client side (e.g. executables).

Resources, such as resource 104, provide services which are valuable to a user (e.g. to the delegator) and often use mechanisms to enforce access control, e.g. for security and privacy reasons including confidentiality (e.g. pictures, medical records) and integrity. The delegator may be defined as an authorized entity that manages the access control of a resource in a way that another entity, (e.g. the delegatee 102), can use the resource in a way that was previously explicitly or implicitly agreed between the authorized entity (e.g. delegator 101) and the other entity (e.g. delegatee 102). A delegatee may be defined as an entity that requests access (or is granted access) to a resource (e.g. resource 104) from a delegator (e.g. delegator 101) which is authorized to administrate the access control mechanism of that resource. The process of delegation refers to the fact that the delegator authorizes the delegatee to access the particular resource. There are many ways in which the delegation may be implemented. The delegator may for example grant access by configuring the access control mechanism of the resource accordingly and providing information to the delegatee how to invoke the service. This management operation could, for example, involve the creation of a new credential, uploading an X.509 certificate of the delegatee to an access control list, or modifying an existing security policy. Any suitable mechanism may be used to grant access to the resource. Delegation is separation from impersonation, i.e. where an entity temporarily acts as another entity in order to gain access to a resource.

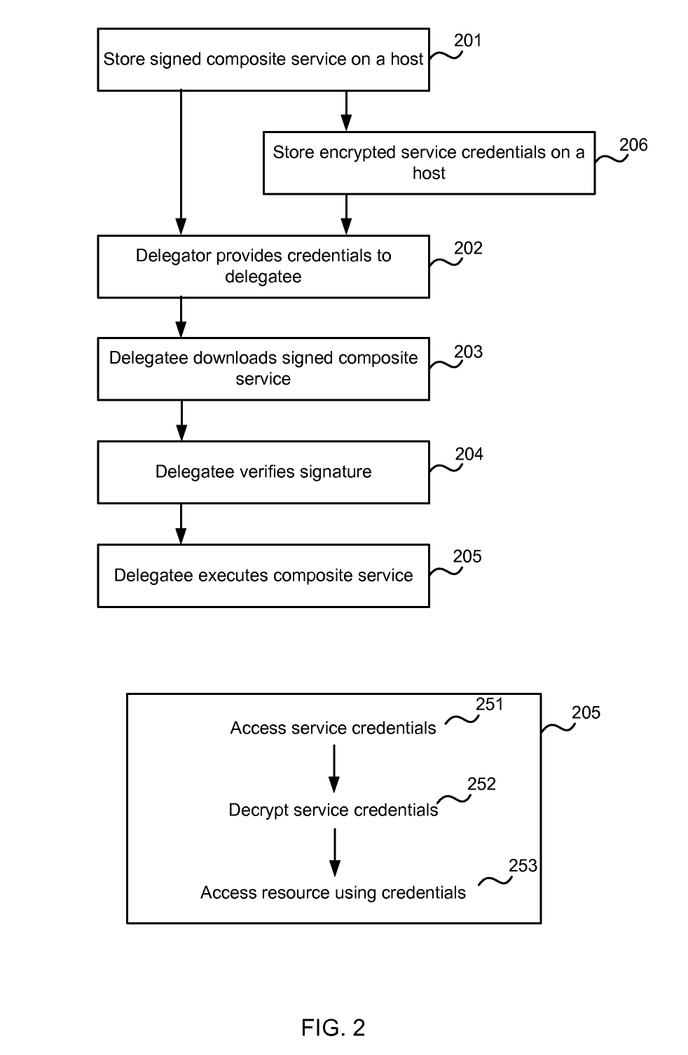

The operation of the system 100 shown in FIG. 1 can be described with reference to FIG. 2, which shows a flow diagram of an example method of operation of a delegation system. The arrows between elements in FIG. 1 are labeled with reference numerals which correspond to method blocks shown in FIG. 2. Although FIG. 1 shows double and single ended arrows, it will be appreciated that communication between elements may be bidirectional or unidirectional and there may be additional communication flow which is not shown in FIG. 1. The same also applies to subsequent FIGS.

As shown in FIGS. 1 and 2, a signed composite service (such as a mash-up) 105 is stored on a host 103 (block 201). This signed composite service 105 may be placed on the host 103 by the delegator 101 or by another entity (e.g. a software vendor, as described in more detail below). The delegator 101 provides credentials to the delegatee 102 (block 202) and these credentials comprise one or more credentials to enable the delegatee 102 to verify the signature of the composite service and, where required, to access the resource 104 (e.g. one or more credentials to enable decryption of service credentials, as described in more detail below). In many examples, the credentials provided to the delegatee (in block 202) comprise a single credential. The delegatee 102 downloads the signed composite service 105 from the host 103 (block 203), verifies the signature of the composite service (block 204) using the credential(s) received from the delegator (in block 202) and if the verification (in block 204) confirms that the composite service is the expected composite service and has not been tampered with, the delegatee executes the composite service (block 205). In order to execute the composite service, the composite service code may run temporarily, e.g. inside a browser or browser plug-in running on the computer. In other examples, the composite service code may be installed on the computer to which it is downloaded. When the composite service is executed (in block 205), the resource 104 is accessed. It will be appreciated that the composite service may access more than one resource and therefore the system 100 may comprise a plurality of resources. The composite service may also access any resource zero, one or more times.

Where the delegatee 102 requires credentials to access the resource 104, these may be provided to the delegatee directly by the delegator (in block 202). Alternatively, encrypted service credentials may be stored on a host (block 206) and the credentials provided to the delegatee (in block 202) may include information to enable these service credentials to be decrypted. The composite service and the encrypted service credentials may be stored on the same host or may be stored on different hosts. In a further example, service credentials may be stored in unencrypted form on a trusted host. The host on which the credentials are stored is referred to as a credential store. The address of the credential store may be provided to the delegatee by the delegator (e.g. in block 202) or may be stored along with the composite service (e.g. as configuration data).

Where encrypted service credentials are stored on a host (in block 206), the execution of the composite service (in block 205) may comprise: retrieving the encrypted service credentials from the host on which they are stored (block 251), decrypting the service credentials (block 252), e.g. using the credentials provided by the delegator (in block 202), and accessing the resource using the decrypted service credentials (block 253). Alternatively, the steps of retrieving the encrypted service credentials (block 251) and decrypting these credentials (block 252) may be performed separately (e.g. prior) to the execution of the composite service (in block 205).

There are many applications for the system and method described above. In an example, Bob is a traveling salesman. He is leaving for a business trip where he has to travel long distances by car. He has been having health issues and his heart is weak. His friend Alice is concerned about him leaving and wants to be able to locate and assist him in case of problems.

Bob is registered with a medical record service (a resource) where his health data is stored. He is further registered with a location service (another resource) that provides his real time location. In this example scenario, Bob's physical health status and his location are available through these services, e.g. as provided through a heart monitor device with cell phone connection and a GPS-based anti-theft system in his car.

Bob does not want to hand out his credentials for the two services to Alice, because he wants to delegate a subset of his privileges. He simply wants Alice to know where he is and what his physical condition is. Therefore, Bob (as delegator) creates (or gets from a third party) a composite service that displays a combination of his medical and location information obtained from the two services. Alice (as delegatee) can use this composite service to view Bob's medical and location information.

Alice may access the composite service frequently and from different locations. Bob stored the composite service at a web host on the Internet. Alice knows the web address of this host and can download the composite service code and execute it locally on whatever computer she is using (and which has internet access and the ability to execute the downloaded code). The composite service code needs not necessarily to be installed on each computer; it is more likely that the mash-up code runs temporarily inside the browser.

Bob stored the composite service code at a web host that is operated by Eve. Bob trusts Eve to behave orderly, which means that Eve runs the host properly and guarantees delivery of services. However, Bob knows that Eve is honest but curious and may try to collect Bob's data. Eve may therefore be considered to be an untrusted host. The method described herein (and shown in FIG. 2) enables Alice, but not Eve, to access the resources behind the composite service, i.e. the health and location of Bob. Furthermore, the method enables Bob to provide only a subset of rights to Alice to enable her to access his underlying personal services (e.g. she may only have access to a few aspects of his medical information) and he can revoke these access rights granted to Alice at any time (e.g. when he returns from the business trip).

The composite service is signed and the service credentials are encrypted. Alice has (or gets from Bob, e.g. in block 202) the credentials to verify the composite service signature and decrypt the service credentials. When Alice wants to invoke the composite service, which will in turn invoke the underlying services, she downloads everything from Eve (e.g. in block 203) and executes the composite service code (e.g. in block 205). This method combines the trust advantages of a local running application with the availability advantages of an online service. Bob keeps control over who can access the composite service and has the guarantee that Eve hosting the composite service cannot access the underlying services.

Different forms of cryptography may be used in the methods described herein and the key material (e.g. as used in encryption of credentials etc) may comprise symmetric or asymmetric keys. In example implementations, different types of credentials including asymmetric key pairs, symmetric keys, and username/password may be used. For the purposes of explanation only, the following description refers to the use of public keys (also referred as security tokens, K_{P}) and private keys (also referred as proof tokens, K_{S}). In variations or extensions of the methods described, the public key and the private key may be the same symmetric key or may be mapped to other cryptographic schemes such as username/password, anonymous credentials, or identity-based encryption.

The methods described herein provide the improved security and trust as may be typically provided when an application is run locally. Additionally the methods provide improved availability, i.e. the ability to access a service or application from anywhere. The methods enable a composite service stored on a host to access resources (which may be sensitive in nature) which are protected by access control without the hosting party gaining access.

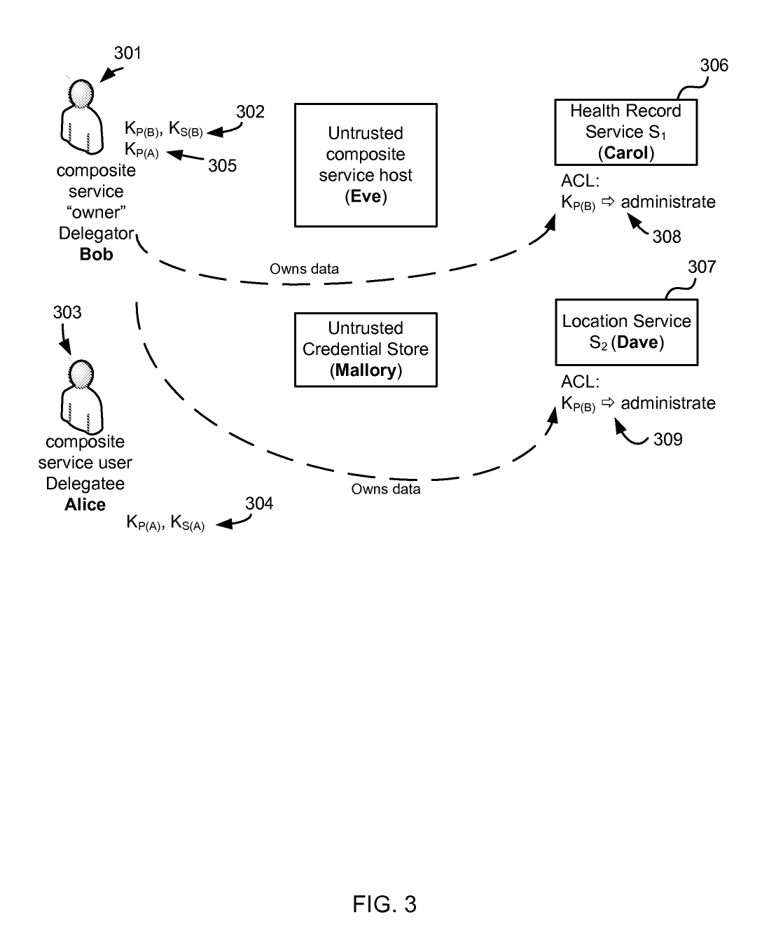

A more detailed example of a method of delegation can be described with reference to FIGS. 3-8. For the purposes of the following explanation only, the following characters are used:
Bob—delegator, who owns a composite service that summarizes his private information
Alice—delegatee, a friend of Bob's who is to access Bob's composite service
Eve—host that stores Bob's composite service
Mallory—host that Bob uses to store credential data for Alice
Carol—operates a resource (e.g. a service) that provides data for Bob's composite service
Dave—operates a resource (e.g. another service) that provides data for Bob's composite service
   It will be appreciated that these characters are only used to assist in understanding the methods described. As described above, the same host may be used to store both the composite service and the credential data. One or both hosts may be untrusted. For the purposes of the following explanation, it is assumed that the delegator Bob wants to grant access to his composite service (M₁) and related resources (S₁ and S₂) to delegatee Alice. For the purposes of the following description, the resources are services, although it will be understood that this is by way of example only and other resources may alternatively be used.

The creation of the composite service itself is not described herein and the composite service may be implemented in any suitable technology. For example, in a web browser the composite service could be implemented with Microsoft® Silverlight™ or Java Applet. The methods described herein may also be applied to other forms of downloadable code such as Microsoft® Windows Vista gadgets, or Java Web Start.

In the following description, the following nomenclature is used:
K_{P(B)}—public key of delegator (Bob)
K_{S(B)}—private key of delegator (Bob)
K_{P(A)}—public key of delegatee (Alice)
K_{S(A)}—private key of delegatee (Alice)
M₁—composite service (of Bob) and all necessary data to run it, e.g. configuration data
K_{P(A, M1)}, K_{S(A, M1)}—credential (of Alice) to access composite service M₁ (provided by Bob)
S₁—service owned by Bob and accessed during the execution of M₁
K_{P(A, S1)}, K_{S(A, S1)}—credential of delegatee Alice to access service S₁ (provided by Bob)
S₂—another service owned by Bob and accessed by M₁
K_{P(A, S2)}, K_{S(A, S2)}—credential of delegatee Alice to access service S₂ (provided by Bob)
Addr_{S1}—service address of S₁
Addr_{S2}—service address of S₂
E_{KP(A, M1)}(Addr_{S1}, K_{S(A, S1)})—Service address of S1 and credentials to access it encrypted with Alice's public key for the composite service
E_{KP(A, M1)}(Addr_{S2}, K_{S(A, S2)})—Service address of S₂ and credentials to access it encrypted with Alice's public key for the composite service
S_{KS(B)}(M₁)—Signature of M₁ by Bob
Addr_{E, M1}—Address of composite service M₁ at Eve's web host
Addr_{M, M1}—Address of credentials for M₁ (e.g. the encrypted service credentials) at Mallory's web host

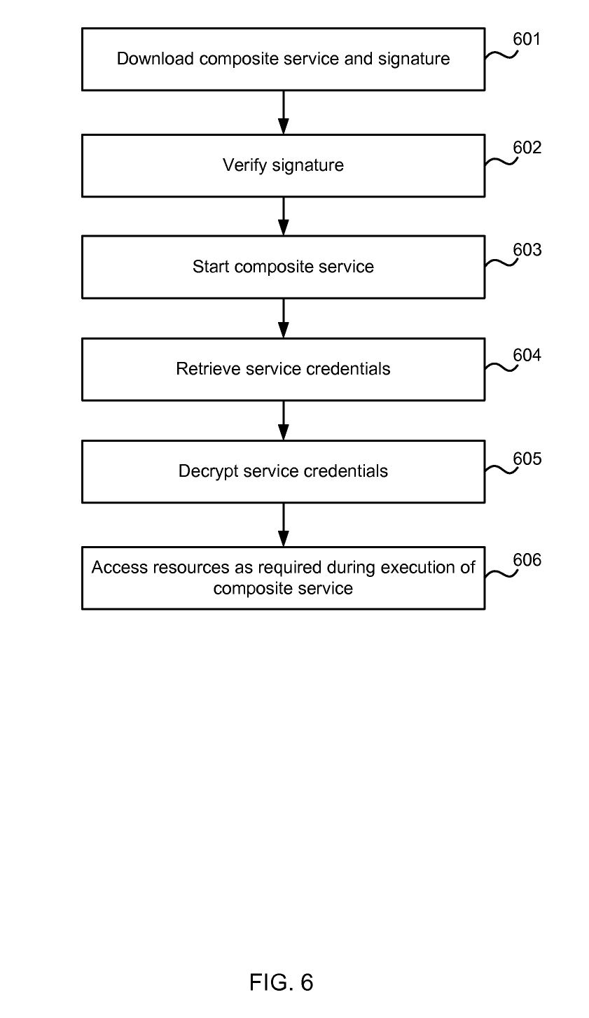

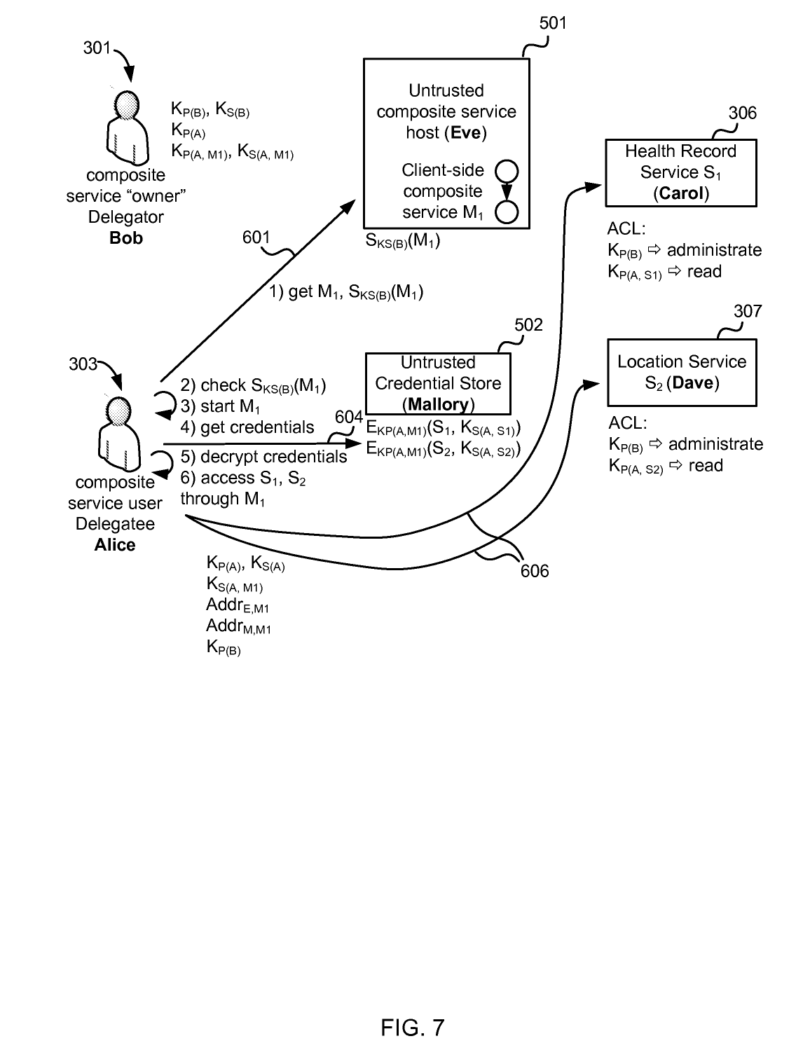

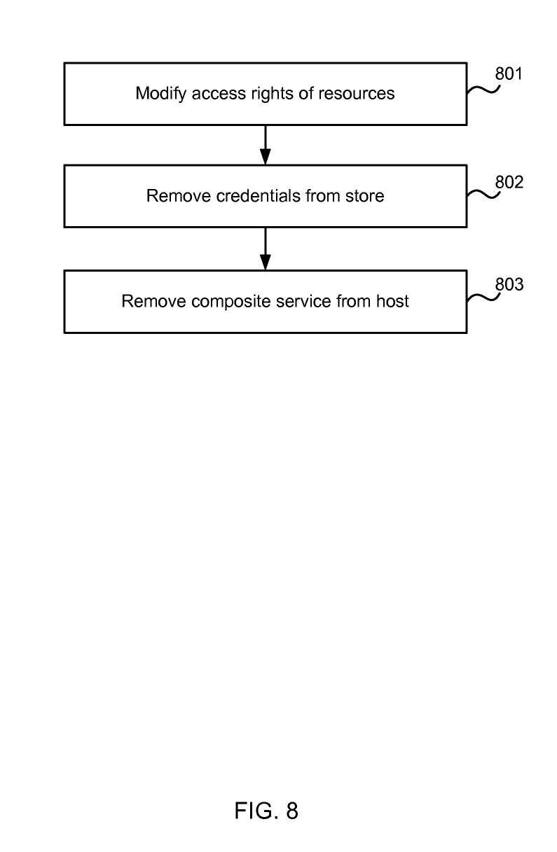

The method may be considered in three phases: delegation (as shown in FIGS. 3-5), access (as shown in FIGS. 6-7) and revocation (as shown in FIG. 8). In the delegation phase Bob sets up everything so that Alice can access his composite service and in the access phase Alice executes the composite service. In the revocation phase, which is optional, Bob revokes Alice's rights on his composite service.

FIG. 3 shows a schematic diagram of the situation at the beginning of the delegation phase. The diagram shows the delegator, Bob, 301 who is equipped with his own key pair 302, consisting of a public and a private key. Delegatee, Alice, 303, also has her own key pair 304 and in this example, Bob knows Alice's public key, K_{P(A)} 305 (e.g. for use in block 408 as described below). Each of the services 306, 307 which provide data for Bob's composite service are shown having an access control list (ACL) 308, 309 which indicates that Bob may administer the list after authenticating with his private key. Other access control mechanisms may alternatively be used.

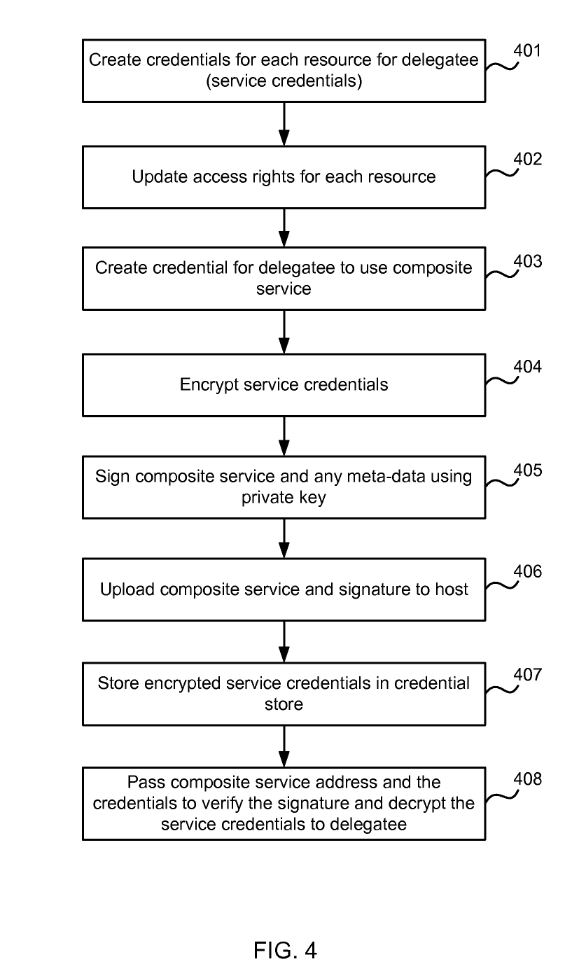

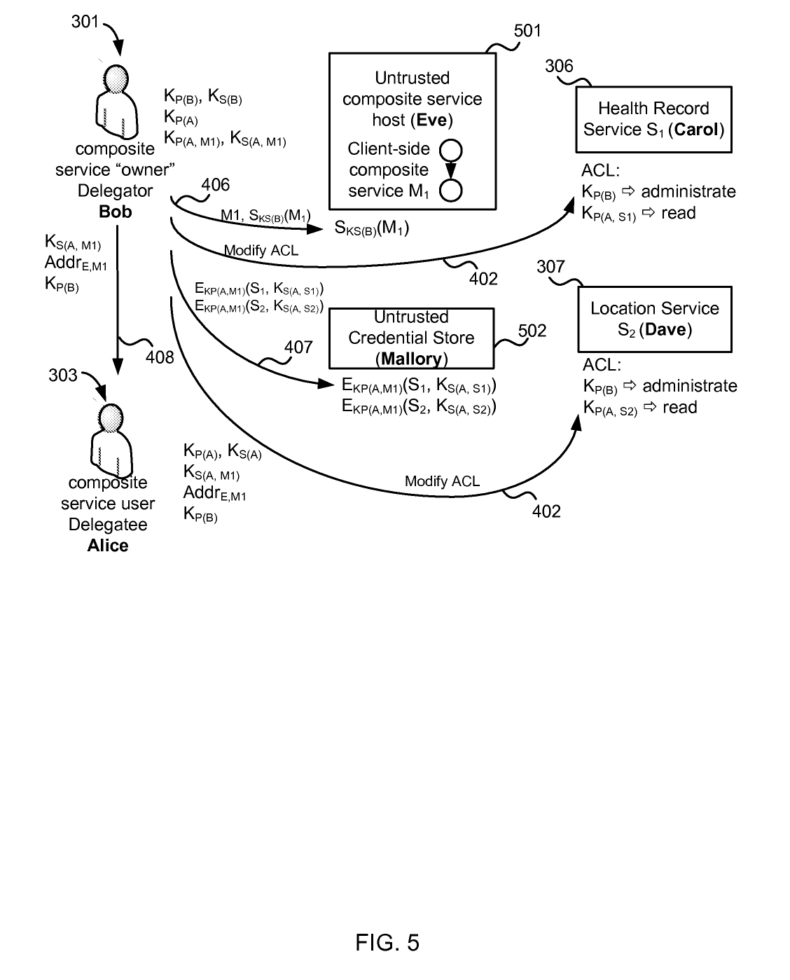

The delegation process is shown in the example flow diagram of FIG. 4 and in FIG. 5 which shows a schematic diagram of the situation at the end of the delegation phase. Arrows in FIG. 5 are labeled with reference numerals that correspond to the method blocks shown in FIG. 4. Bob decides to let delegatee Alice access his composite service. Bob is authorized to administrate each service behind the composite service, i.e. S₁ operated by Carol and S₂ operated by Dave. In this example, Bob may not want to share his credentials for S₁ and S₂ with Alice, because that would allow Alice to impersonate Bob. Hence, Bob creates two credentials (block 401), e.g. key pairs, for Alice, one for each service. The keys for Alice to use for service S₁ are public key K_{P(A, S1)} and private key K_{S(A, S1)}; the keys for Alice to use for service S₂ are public key K_{P(A, S2)} and private key K_{S(A, S2)}.

Bob modifies the access rights (e.g. an Access Control List) of both services S₁ and S₂ to grant appropriate rights to the owner of the private key K_{S(A, S1)} and K_{S(A, S2)} (block 402). The granted permissions correspond to the requirements/expectations of Bob's composite service M₁. For instance, if the composite service needs write access to service S1, then Bob grants write access to the owner of K_{S(A, S1)} (e.g. Alice in this example). Any access control mechanism may be used and the granularity of access which can be granted by the delegator (Bob) may be dependent upon the actual access control mechanism of the particular service.

Bob creates a specific credential for Alice to use the composite service M₁ (block 403) and this credential may be referred to as K_{P(A, M1)} and K_{S(A, M1)}. This key material is used to encrypt the credentials necessary to access the services. Bob encrypts the credentials K_{S(A, S1)} and K_{S(A, S2)} with K_{P(A, M1)} (block 404) so that only Alice, who will get the private key K_{S(A, M1)} from Bob, can decrypt the credentials necessary to access S₁ and S₂. The encrypted credentials for S₁ may be referred to as E_{KP(A, M1)}(Addr_{S1}, K_{S(A, S1)}) and the encrypted credentials for S₂ as E_{KP(A, M1)}(Addr_{S2}, K_{S(A, S2)}). Each encrypted container holds two pieces of information: the service address (Addr_{S1} or Addr_{S2}) and the credential which is necessary to access the service (K_{S(A, S1)} or K_{S(A, S2)}).

The composite service and any meta-data that is necessary to run it (e.g. configuration data) are referred to as M₁. Bob signs M₁ (block 405) to make sure that Eve cannot replace it with a modified version. Bob uses his private key K_{S(B)} to sign the code and the result may be referred to as S_{KS(B)}(M₁).

So far, Bob has computed everything on his local machine and has not shared any information with any other person, including Alice. Now, Bob uploads the composite service M₁ and its signature S_{KS(B)}(M₁) to the distrusted web host 501 operated by Eve (block 406). The address of the stored composite service may be referred to as Addr_{E,M1}. Additionally Bob stores the encrypted credentials E_{KP(A, M1)}(Addr_{S1}, K_{S(A, S1)}) and E_{KP(A, M1)}(Addr_{S2}, K_{S(A, S2)}) at a distrusted credential store 502 (block 407). The address of the credentials at the credential store may be referred to as Addr_{M,M1}. The credential store 502 may be some publicly accessibly web space which Bob uses to place the credentials for Alice. In this particular example, it is assumed that Mallory operates this credential store. Like Eve, Mallory may not be trustworthy. In some examples, the credential store 502 and the host 501 may be combined or may cooperate. This does not affect the operation of the methods described herein.

Finally, Bob gives Alice the information that she needs to execute the composite service M₁ and thus invoke the services S₁ and S₂ (block 408). The information he provides to Alice are the address of the composite service code (Addr_{E,M1}), the credential to verify the signature (K_{P(B)}), and Alice's decryption credential K_{S(A, M1)}. In another example, Bob may provide other information in addition to, or instead of, that described. For example, Bob may give Alice the service credentials rather than storing them in the credential store. Bob may send the information (in block 408) to Alice out of band. Depending on the scenario and on the type of credential, this can, for instance, be done by e-mail or verbally. Bob could, for example, obtain Alice's public key K_{P(A)} to establish a secure channel for key exchange, e.g. encrypted e-mails. Another option would be the use of identity based encryption (IBE) for the same purpose. In this case, the e-mail address of Alice would directly be used as public key in Identity Based Encryption. Assuming that only Alice can get the corresponding private key from the chosen Private Key Generator, only Alice can decrypt the credential K_{S(A, M1)}. A further option would be to use another secure channel (e.g. phone call, memory stick etc).

It will be appreciated that although the delegation process shown in the example flow diagram of FIG. 4 includes method blocks in which the composite service (and any meta data) is signed (block 405) and the signed data and signature is uploaded to a host (block 406), these method blocks may be omitted if the method is repeated. For example, if Bob wished to delegate access to another individual (e.g. Fred), the delegation process may omit blocks 405 and 406.

The access process is shown in the example flow diagram of FIG. 6 and in the schematic diagram shown in FIG. 7. Arrows in FIG. 7 are labeled with reference numerals that correspond to the method blocks shown in FIG. 6. At the end of the delegation phase Alice has all information to which is required to access Bob's composite service. In the access phase she uses the address Addr_{E,M1} to download the code of the client side composite service M₁ plus the associated signature S_{KS(B)}(M₁) (block 601). Alice uses Bob's public key K_{P(B)} to verify the signature on M₁ (block 602). The signature lets Alice verify that she has downloaded the right piece of code prior to execution of the code itself and/or prior to any credential being handed to the composite service. This prevents Eve from mounting a phishing attack to steal K_{S(A, M1)}, e.g. by replacing M₁. The verification of the composite service signature (in block 602) may, for example, be performed by the web browser running on Alice's local machine or by a plug-in installed in this browser.

When the signature is verified by Alice, the composite service is started (block 603), i.e. the downloaded piece of code is executed locally on Alice's machine. For instance, M₁ could be a piece of code (e.g. Microsoft® Silverlight™, Java applet etc) which is executed in Alice's web browser. Alternatively M₁ could be an application that Alice installs on her machine if appropriate sandboxing mechanisms are available. The composite service retrieves the encrypted credentials from Mallory's credential store (block 604). The composite service knows the address of the credential Addr_{M,M1} because it is part of M₁'s configuration data (or meta-data). In this example, the encrypted credentials are: E_{KP(A, M1)}(Addr_{S1}, K_{S(A, S1)}) and E_{KP(A,M1)}(Addr_{S2}, K_{S(A, S2)}). The credential K_{S(A, M1)} which is required to decrypt the credentials (in block 605) is provided to the composite service by Alice. In course of its execution, the composite service M₁ accesses S₁ and S₂ with appropriate credentials K_{S(A, S1)} and K_{S(A, S2)} (block 606).

The revocation process is shown in the example flow diagram of FIG. 8. In order for Bob to revoke Alice's access rights, he modifies the access control lists (or other access rights) of S₁ and S₂ (block 801). In addition, he may remove the credentials from Mallory's credential store (block 802) and/or the signed composite service from Eve's composite service store (block 803). Just removing the composite service and credentials (blocks 802-803) does not guarantee that Alice's access rights have been revoked because Alice could hold a copy of the composite service code and the encrypted credentials. To improve the security of the methods described herein, a fresh key pair for each service (K_{P(A, S1)}, K_{S(A, S1)}, K_{P(A, S2)}, K_{S(A, S2)}) may be generated for every act of delegation (in block 401), so that stored keys become useless.

As described above, the revocation phase is optional as it may not be necessary to revoke rights once granted. In another example implementation, rights may be granted for a defined period of time (in the delegation phase) such that they expire and therefore a specific revocation act is not required. The ability to set a lifetime of the access rights may depend on the access control complexity for each resource. Where sophisticated access control mechanisms are used it may be possible to set access rights for a defined period, for a particular number of access attempts etc. In further examples, the composite service may expire.

In the above examples, a different credential or key is used for verifying the composite service and decrypting the service credentials used by the composite service. In other examples, the same credential may be used for both verification of the composite service and decryption of the service credentials, e.g. the delegator's private key (K_{P(B)}).

In a variation on the methods described above, the composite service may be created by a third party rather than by the delegator (e.g. by someone other than Bob). In such a situation, the composite service may, for example, be created by a software vendor and be purchased by the delegator (e.g. by Bob). In this case the composite service may be signed by the software vendor. This vendor signature may be associated with the composite service and retrieved by the delegatee. When the delegatee does not know the vendor, the public key of the vendor may be provided to the delegatee (e.g. in block 408). When the delegatee already trusts the software vendor then the delegatee knows that the delegator purchased the client-side composite service code from a trustworthy source. In another example, the composite service may be signed by the delegator in addition to the software vendor and in this case both the public key of the vendor (or the signature of the vendor) and the public key of the delegator may be provided to the delegatee (in block 408) in order that the signatures can be verified (in block 602).

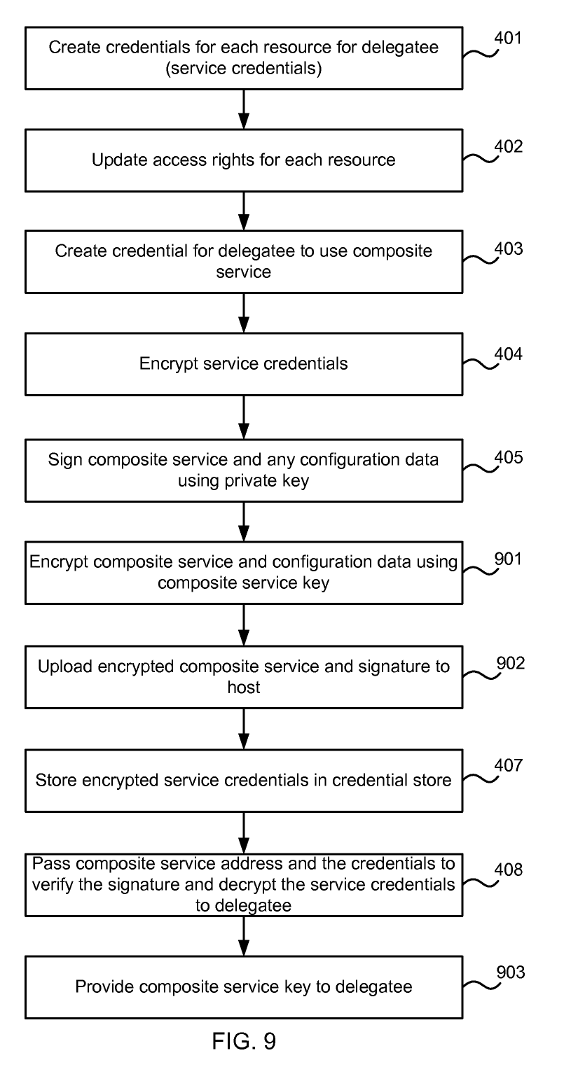

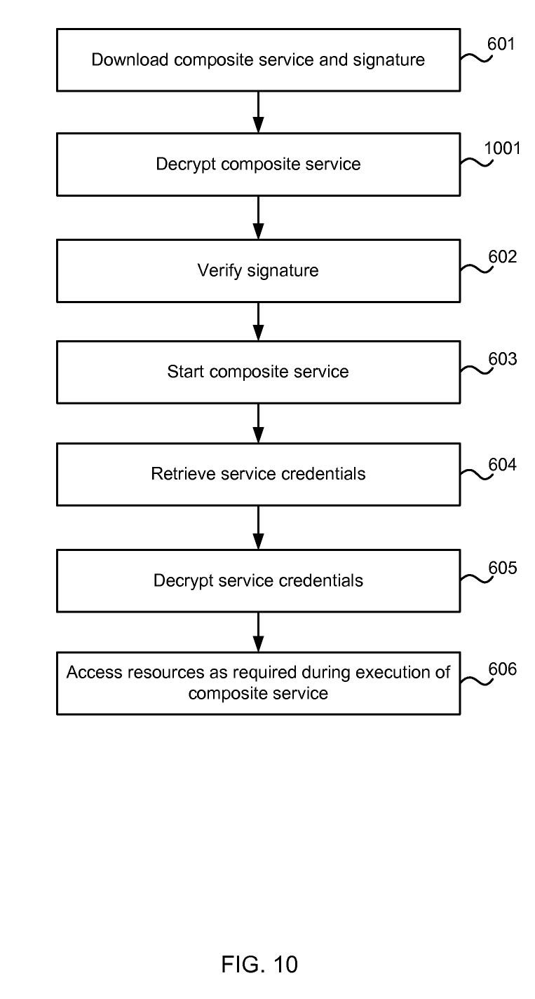

In many examples, the composite service itself may not be particularly sensitive and in the examples described above, the composite service is not encrypted before it is uploaded to the host (in block 406). In another variation of the methods described above, however, the composite service may be encrypted. This may, for example, be because the composite service is sensitive (e.g. it contains a new or secret algorithm) or because the delegator does not want to disclose what services he subscribes to. This variation is shown in FIGS. 9 and 10. In order to address this scenario, Bob encrypts the composite service M₁ (code and configuration data) before storing it on Eve's host (blocks 901-902). A new key K_{M1} may be used for the encryption (in block 901) and this key is made available to users of the composite service. For instance, Alice may be provided with E_{KP(A,M1)}(K_{M1}) (e.g. in block 903) to decrypt the encrypted composite service, E₁=E_{KM1}(M₁) before executing the composite service. In other examples they key could be stored in the credential store. The method (shown in FIG. 9) introduces an additional step for Alice: before she can run the composite service she decrypts it (block 1001).

Although the methods shown in FIGS. 9 and 10 and described above involve the generation of a new key to encrypt the composite service, in other examples, an existing key (e.g. Bob's public key) may be used instead of a new encryption key.

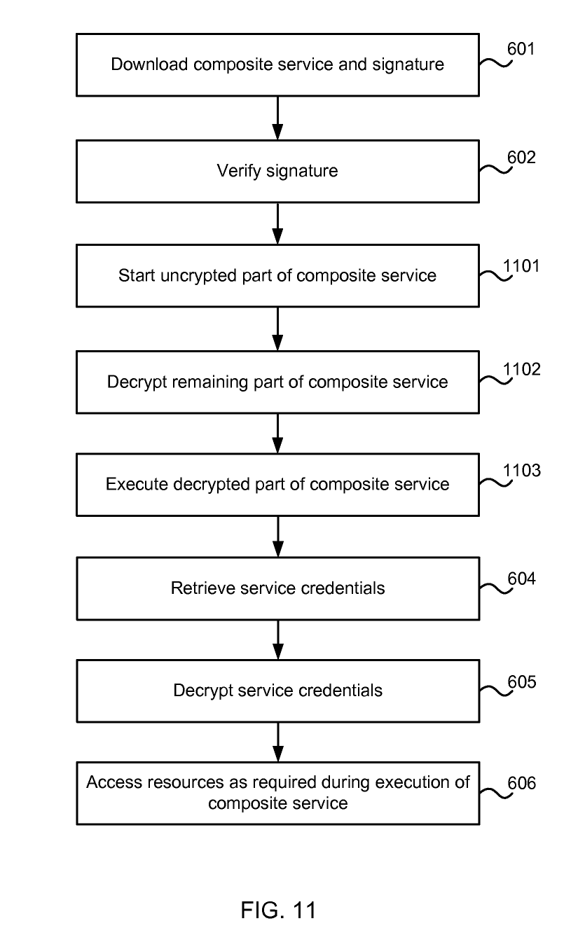

In a further variation of that described above, the encrypted composite service (e.g. as generated in block 901) may comprise two parts: an unencrypted code part M₁₁ and an encrypted code part E₁₂=E_{KM1}(M₁₂) that can be decrypted by Alice with K_{S(A,M1)} as described above. FIG. 11 shows a flow diagram of an example of the access phase in such an example. The unencrypted part M₁₁ can be executed first without any prior decryption (block 1101). The unencrypted part contains the decryption algorithm for the encrypted part and a simple user-interface which allows Alice to enter her decryption key K_{S(A,M1)}. After Alice has provided this key, the unencrypted part M₁₁ uses it to decrypt E₁₂ (block 1102) and executes the decrypted result M₁₂ (block 1103). All confidential aspects of the composite service may be part of M₁₂. This variation does not require an extra key as Alice already receives the decryption key K_{S(A,M1)} (in block 408). In this example, the signature on the composite service is applied on M₁₁ and E₁₂. For instance S_{KS(B)}(M₁) would be replaced by S_{KS(B)}(M₁₁, E_{KM1}(M₁₂)). This ensures that neither part has been tampered with

In the examples described above, the delegator and the delegatee are different users, e.g. Bob delegates to Alice. The methods may, however, also be used for self-delegation, e.g. for Bob to delegate to himself. This may be used to enable the delegator (e.g. Bob) to access his own composite service from anywhere, e.g. from his computer at home and from a public Internet Cafe. In this case, Bob delegates access to himself, following the procedure above. Therefore, a new credential is created for Bob (K_{P(B,M1)} and K_{S(B,M1)} in block 403), which will be used for the verification of the signature and for decryption of the service credentials.

In some implementations of self-delegation, the new credential may be such that it can be memorized by the delegator. In such a scenario, a single password or pass-phrase may be used to verify the signature (in block 602) and to decrypt encrypted credentials (in block 605) and data (where this is also encrypted, e.g. as described below). In an example a symmetric key K_{S(B,M1)} may be generated using a memorized secret as input parameter, e.g. an AES (Advanced Encryption Standard) key may be generated from a pass-phrase. At the encryption stage (e.g. in block 404), the symmetric key, (e.g. AES), used to encrypt the data and/or credentials can be generated from the memorized secret. By knowing and inputting this secret, the delegatee can enable the composite service to regenerate the same key in another environment in order to decrypt necessary credentials and/or data. The secret may be selected to be strong enough to forbid dictionary attacks. A dictionary attack is a form of attack where a long list of possible values is used in attempt to guess the value of a secret or pass-phrase.

The electronic signature used to verify the composite service (e.g. as created in block 405 and verified in block 602) is based on asymmetric cryptography. However, since the signer (who is usually the delegator) and the verifier (the delegatee) share a secret (in this case the signer and verifier are even the same party), the signature may comprise a message authentication code (MAC). The MAC may be the result of the hash of the composite service code concatenated with the secret. The verification (in block 602) is done by doing the same process (i.e. generating the hash of the composite service code concatenated with the secret) and comparing the generated and the downloaded values.

These techniques which may be used for self-delegation enable the use of a single credential (referred to herein as the secret) to verify the composite service and to decrypt the necessary credentials and/or data.

The methods described above may be further modified to increase their resilience against dictionary attacks and various techniques may be used. In a first example, access to the encrypted service credentials (which is the cipher-text in this method) may be restricted. A combination of access control and encryption may be used to restrict the access to the cipher-text. In a second example, the cost of checking a key may be increased, e.g. by using mechanisms which require higher computational power to perform the decryption (e.g. by using multiple layers of encryption with same key). This would penalize the attacker but may increase the response time to an unacceptable level where the composite service is accessed by legitimate users using devices which have a low computing power (e.g. mobile telephones). In a third example, interaction with the (distrusted) service provider (or the credential store) may be required when checking a key. In such an example, the key used to encrypt the service credentials (or other data) may depend on a secret known by the service provider (or the credential store) in order to force an interaction with this entity for each decryption.

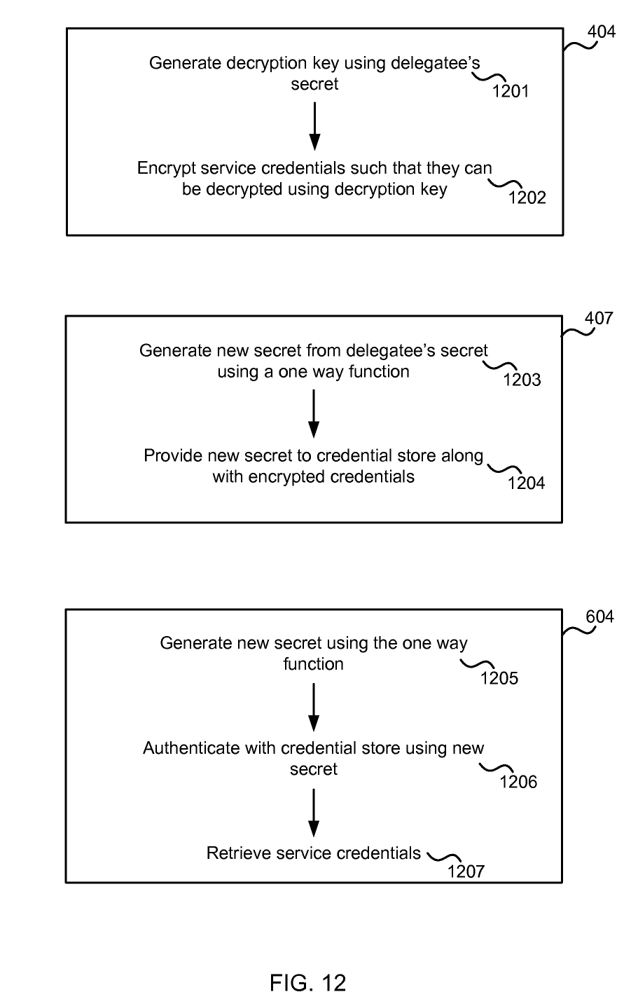

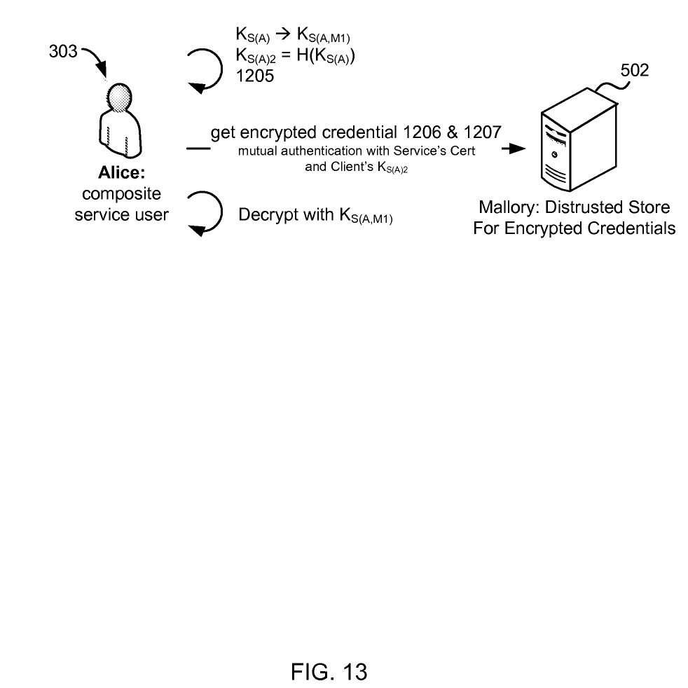

FIGS. 12 and 13 show example implementations of parts of the delegation and access phases which use the third of the approaches given above to increase resilience to dictionary attacks (e.g. an implementation of blocks 404, 407 and 604). In the delegation phase, the delegatee's (e.g. Alice's) secret (which is generated by Bob and communicated to Alice) is used to generate the decryption key K_{S(A,M1)} (block 1201). In an example, the key may be a symmetric key, e.g. AES, and this may be expressed as K_{S(A,M1)}=K_{P(A,M1)}. This key is used to encrypt the service credentials (block 1202) before they are stored in the credential store (in block 407). The decryption key may be passed to Alice by Bob (e.g. in block 408) or may alternatively be regenerated by Alice to avoid providing her with additional credentials.

Although in FIGS. 12 and 13, her credential is generated by Bob, in other examples, Alice may be able to choose or change her credential (e.g. password) and a mechanism may be provided to provide the credential to Bob in a secure manner. Similarly in the other examples described herein, the delegatee (e.g. Alice) may be able to choose or change her credential.

The delegatee's secret K_{S(A)} is also used to create another secret K_{S(A)2}, (e.g. a new username/password) with a one-way function H₁ (block 1203) so that K_{S(A)} cannot be computed from K_{S(A)2}. In many examples this additional secret is generated by Bob, although alternatively this may be generated by Alice and communicated to Bob. An example of a one-way function is a hash function. This new secret K_{S(A)2} is provided to the credential store along with the encrypted service credentials (block 1204) such that the credential store (e.g. Mallory 502) can authenticate the delegatee (e.g. Alice 303) but cannot decrypt the data (as the credential store does not know K_{S(A)}).

In the access phase, the delegatee (e.g. Alice) also generates the new secret K_{S(A)2} from their first secret K_{S(A)} using the same one-way function (block 1205) and this new secret is used by the delegatee to authenticate to the credential store (block 1206), who may be a distrusted party, in order to retrieve the encrypted service credentials (block 1207). Having retrieved the encrypted service credentials, they can be decrypted using the decryption key K_{P(A,M1)} (in block 605).

The method described above and shown in FIGS. 12 and 13 reduces the possibility of an attacker obtaining access to the delegator's (e.g. Bob's) data and/or services while not impacting the delegatee (e.g. Alice) because the delegatee does not need to deal with any additional credentials.

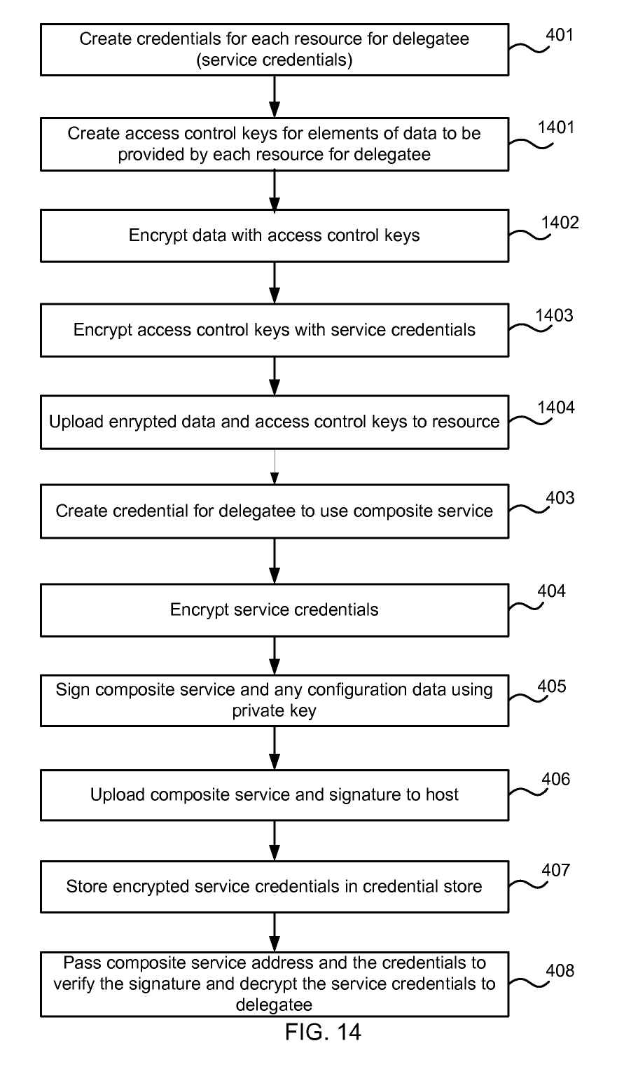

In the above examples it was assumed that the resources (which are services in the examples above) used by the composite service are trusted. The following variation, which is described with reference to FIGS. 14-16, enables use of resources which are (or may be) distrusted. In the delegation phase, as shown in FIG. 14, instead of updating access rights for a resource (e.g. service S₁ 1601), e.g. as in block 402 of FIG. 4, the delegator (e.g. Bob 301) creates access control keys K₁, K₂ (block 1401) and encrypts one or more pieces of data (data₁, data₂) with those access control keys (block 1402). As a result, the party offering the resource and storing the data cannot decrypt them. Next, the delegator (Bob) encrypts those keys K₁, K₂ accordingly to the access control he wants to grant to the delegatee (Alice) and any other parties (block 1403). For instance Bob can encrypt K₁ with key K_{P(A, S1)} and provide this key to Alice in order to let her access data₁. As previously, the key K_{P(A, S1)} can be stored in the (distrusted) credential store (in block 407). The encrypted data (e.g. E_{K1}(data₁)) and the encrypted access control keys (e.g. E_{KP(A, S1)}(K₁)) are uploaded to the resource 1601 (block 1404).

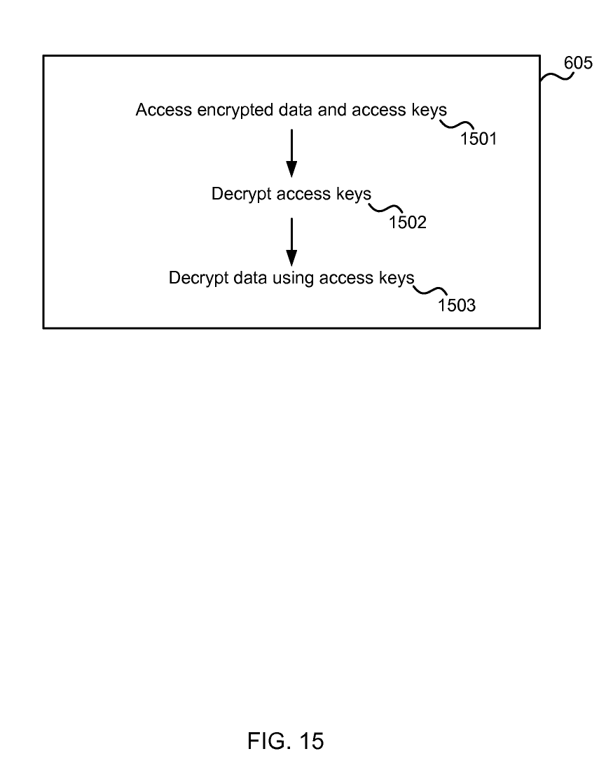

In the access phase, the delegatee only sees minor differences. As shown in FIG. 15, in accessing the resources as required during execution of the composite service (block 606), the delegatee (e.g. Alice) accesses the encrypted data and encrypted access keys (block 1501), decrypts the access keys (block 1502) and then uses the decrypted access keys to decrypt the data (block 1503).

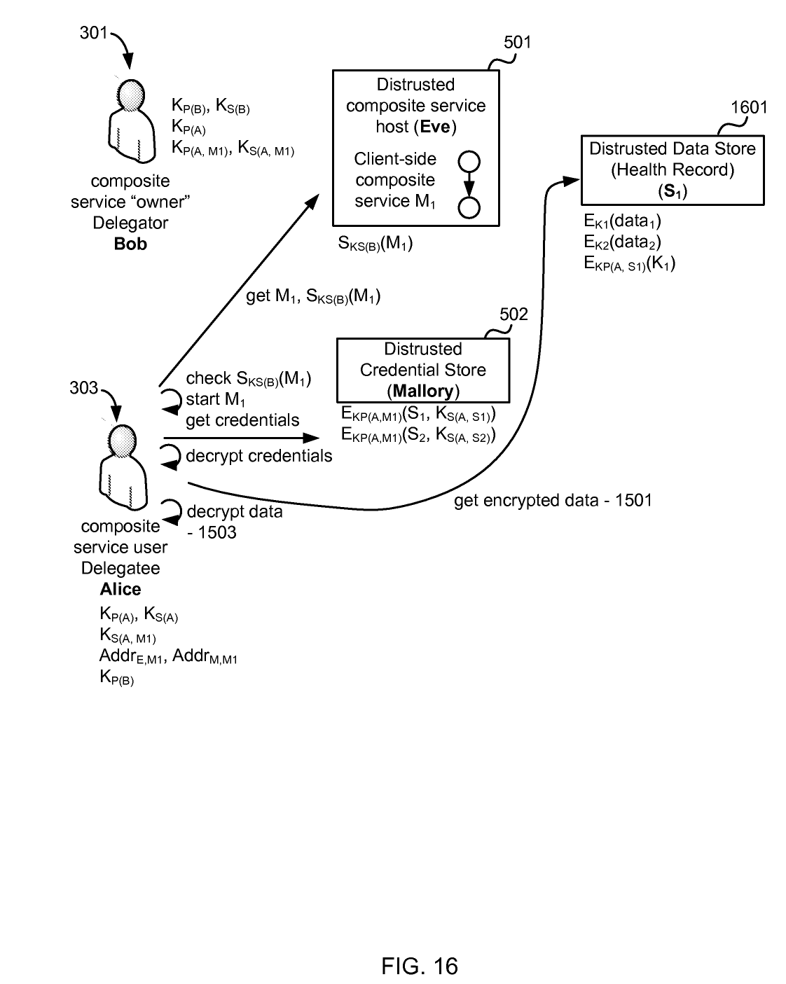

In the example shown in FIG. 16, composite service host 501, the credential store 502 (which may also be referred to as a key store), and the resource 1601 could all be run by the same party (which may be distrusted party) or different parties may run one or more of these elements without affecting the methods described above. In this example, the resource 1601 could be a publicly available web page or web server because the data is stored in an encrypted manner such that only the delegatees can access the decrypted data.

Although the above examples are described in relation to a distrusted host and a distrusted credential store, the methods are also applicable to other scenarios, e.g. where these entities are trusted or where their trust status is not known. The methods are also applicable where the access to the resource is public instead of being restricted. As described above, the delegator may be the same as, or different from, the delegatee.

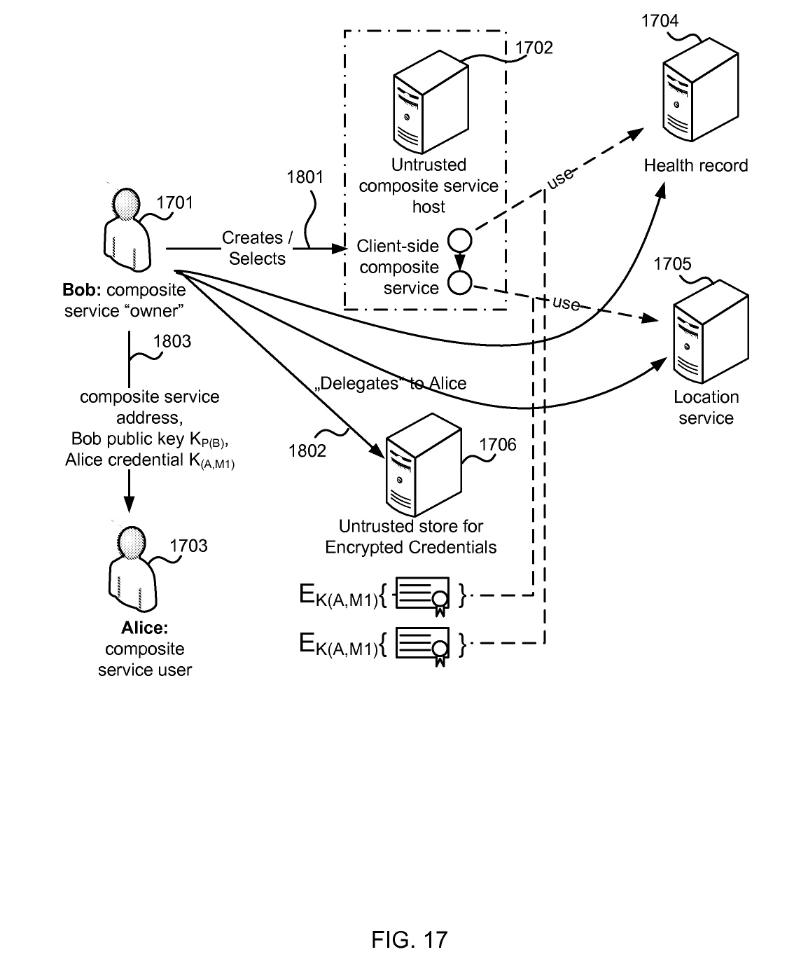

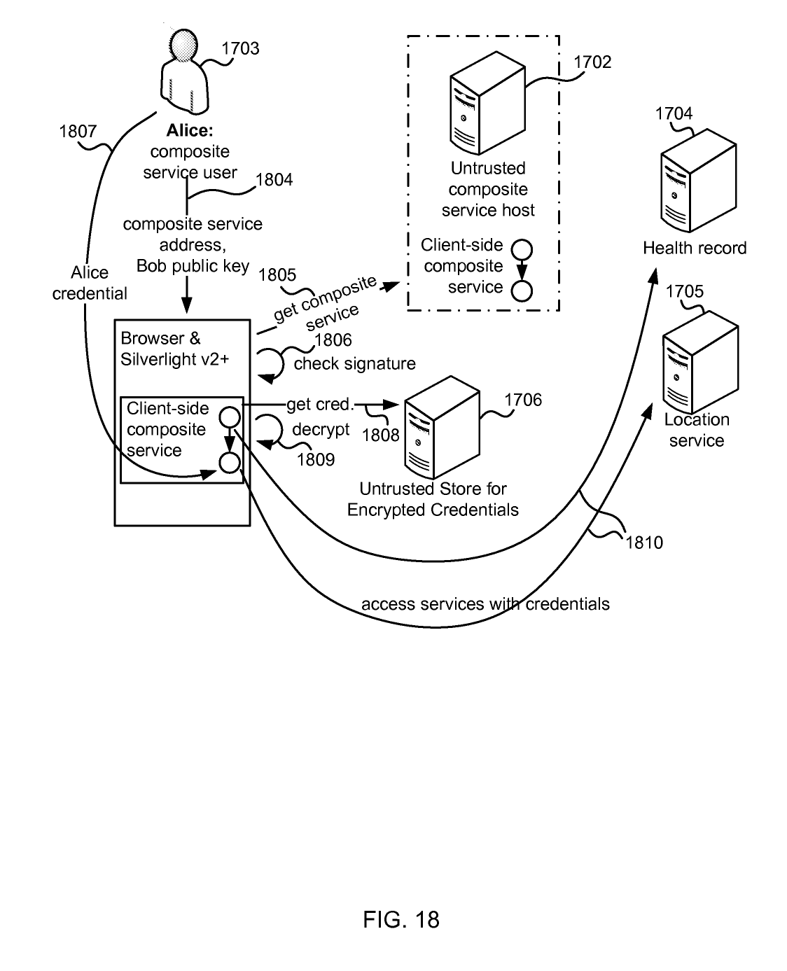

The following description, with reference to FIGS. 17 and 18, describes a specific implementation of the techniques described above by way of example only. This example uses a composite service which is implemented with Microsoft® Silverlight™ 2.0 and which runs within the delegatee's web browser.

Bob 1701 (the delegator) creates a new Microsoft® Silverlight™ page or selects and existing one and signs the resulting files. The signature is embedded in the HTML page, which is stored at the distrusted host 1702 (as indicated by arrow 1801). This composite service displays a combination of medical and location information to quickly locate and help Bob (e.g. in case of an accident or other incident).

In order to give Alice 1703 access to this webpage Bob configures both resources that are used by the composite service (health record 1704 and location service 1705). For instance, a new username, random password, and corresponding privileges can be added to the access control list. Bob creates a new AES key, uses this key to encrypt the service passwords, and stores those encrypted credentials at the distrusted credential store 1706 (as indicated by arrow 1802).

Bob then sends Alice an e-mail or other form of message (as indicated by arrow 1803) containing:
the address of the composite service: e.g. the URL of the distrusted composite service store,
the credential to verify the signature: e.g. Bob's public key, and
the key to decrypt the service credentials used by the composite service: e.g. the generated AES key.
   The URL in the mail may, for example, look like: http://localhost/SLSecurityDemo_Web/DefaultPage.aspx?pk=MIGJAoGBAO2a7 . . . where ‘pk=MIGJAoGBAO2a7 . . . ’ is the full public key of Bob (K_{P(B)}) to be used to verify the signature.

The access phase is shown in FIG. 18. When Alice gets Bob's e-mail, she clicks on the URL (as indicated by arrow 1804). In this example the URL is shaped in a way that it contains the composite service address and Bob's public key as a parameter. The composite service (i.e. the Microsoft® Silverlight™ code), referenced by this URL and the embedded signature are downloaded to Alice's web browser (as indicated by arrow 1805). A plug-in for the browser (e.g. Internet Explorer®) verifies the signature embedded in the HTML page with the Microsoft® Silverlight™ code in the same page and indicates whether the signature is valid (as indicated by arrow 1806). In some examples the browser may verify the integrity and authentication of Microsoft® Silverlight™ code. If the signature is valid, Alice can copy the AES key from the mail to into the composite service (arrow 1807). The Microsoft® Silverlight™ code offers her a form field where she can paste the key to. This copy and paste approach just is exemplarily, other means to provide the key to the client-side composite service are imaginable, e.g. direct file access to Alice's key store or integration of Microsoft® Silverlight™ with the operating system's crypto subsystem. The composite service loads the encrypted credentials from the credential server 1706 (arrow 1808) and the composite service decrypts these credentials (arrow 1809). The credentials are used to access the health record and location service (arrow 1810) and the heath and location data are displayed.

For the purposes of this particular implementation and by way of example only, the public key of the delegator is embedded in the URL as this reduces the number of operations necessary to access the composite service. However, other implementations may use other techniques such that the URL does not contain Bob's public key. Such alternatives prevent the host (Eve) from mounting a phishing attack by creating malicious composite service code and signing it with another key (e.g. the host's public key). In such an attack, when Alice clicks on the correct link in the mail, the host redirects the incoming page request to another URL which contains the host's public key instead of Bob's. The signature verification will succeed since the malicious code can be correctly verified against the host's public key and therefore Alice will run the malicious composite service code. If Alice does not notice the redirection, the malicious composite service may be able to ask Alice for the AES key and steal the credentials for Bob's services.

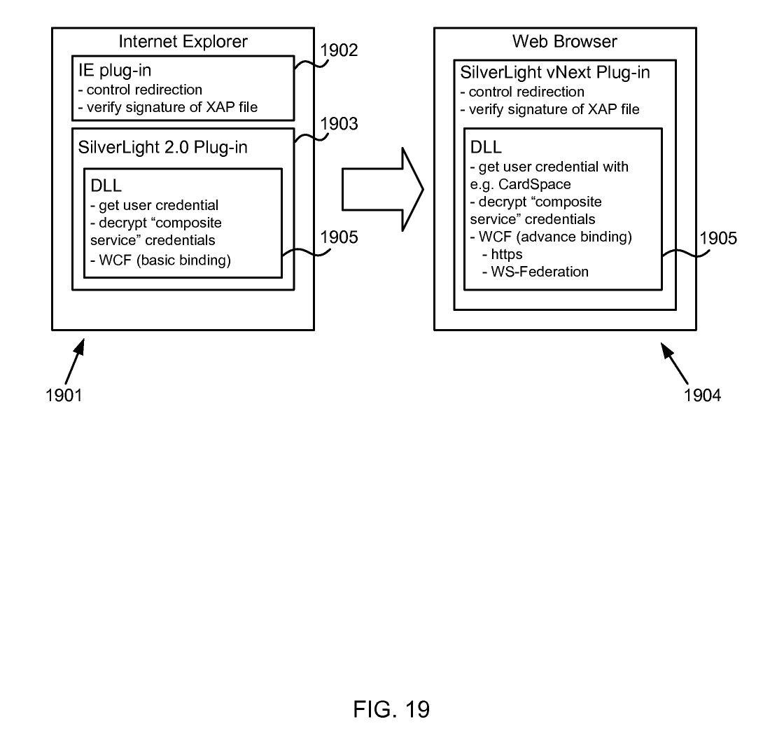

The above example implementation is based on Silverlight™ 2.0 and an example of the schematic architecture is depicted in the left part 1901 of FIG. 19. It consists of a plug-in 1902 for Internet Explorer® that does the verification of the SilverLight™ code. A SilverLight™ plug-in 1903 may also be used to process the security protocol (e.g. which performs the decryption of the service credentials). In other example implementations, the verification of the signature may alternatively be done by the browser or by the Silverlight™ plug-in (instead of by the dedicated Internet Explorer® plug-in 1902). The right part 1904 of FIG. 19 shows another example of a schematic architecture in which the different aspects are implemented in a version of a web browser. In this example SilverLight™ may be used to detect redirection attacks (i.e. the phishing attack described earlier) and verify the signature of SilverLight™ code. The SilverLight™ DLL 1905 may continue to deal with the crypto protocol described herein.

In the examples described above, the delegatee credential is created and provided by the delegator. However, where the delegator knows the public key of the delegatee, the encryption and decryption process may be simplified and may be automated. In further examples, groups of delegatees may be supported so that the delegator can let a group (e.g colleagues, friends, etc) access his composite service.

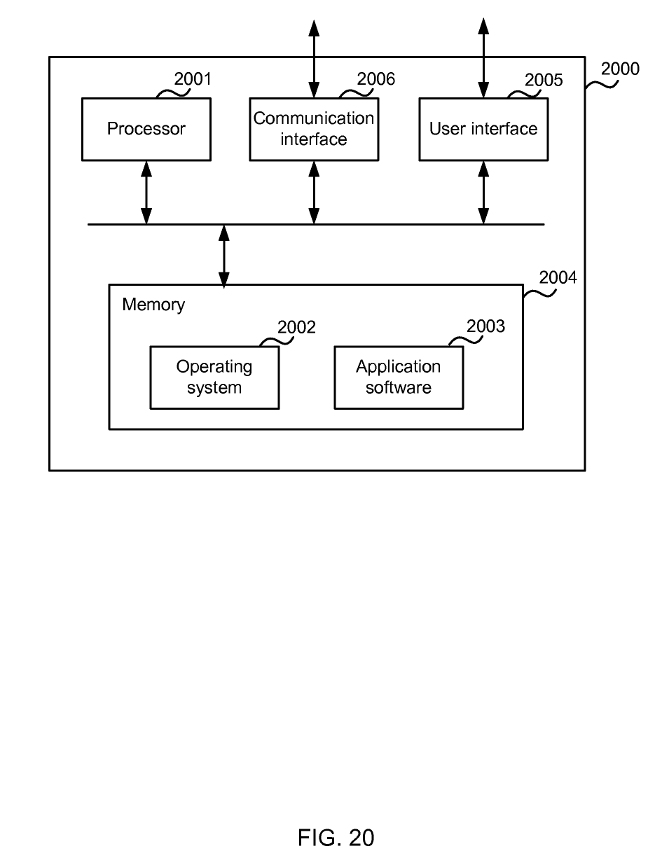

FIG. 20 illustrates various components of an exemplary computing-based device 2000 which may be implemented as any form of a computing and/or electronic device, and in which embodiments of the methods described herein may be implemented. For example, the computing-based device 2000 may be used by the delegator or the delegatee for any of the delegation, access and revocation phases of the methods described herein.

Computing-based device 2000 comprises one or more processors 2001 which may be microprocessors, controllers or any other suitable type of processors for processing computing executable instructions to control the operation of the device in order to perform the methods described herein (e.g. the delegation, access or revocation phase). Platform software comprising an operating system 2002 or any other suitable platform software may be provided at the computing-based device to enable application software 2003 to be executed on the device.

The application software 2003 may depend on the phase that the computing-based device is required to perform and may, for example, comprise a browser and SilverLight™. The application software may further comprise one or more plug-ins, e.g. as described above and shown in FIG. 19. The application software may enable the delegation to be performed in a single mouse click (or in a few operations) by a user. In such an example, the software hides the process steps from the user.

The computer executable instructions may be provided using any computer-readable media, such as memory 2004. The memory is of any suitable type such as random access memory (RAM), a disk storage device of any type such as a magnetic or optical storage device, a hard disk drive, or a CD, DVD or other disc drive. Flash memory, EPROM or EEPROM may also be used.

The computing-based device 2000 further comprises a user interface 2005, to enable the user (e.g. Alice or Bob) to interact with the application software and specify the aspects of the delegation that are required. The computing-based device also comprises a communication interface 2006 to enable the device to communicate with other entities in the system, e.g. the host, the credential store, the services etc.

Additionally, the computing-based device 2000 may further comprise one or more inputs (e.g. which are of any suitable type for receiving media content, Internet Protocol (IP) input, etc) and/or one or more outputs (e.g. an audio and/or video output to a display system integral with or in communication with the computing-based device), which are not shown in FIG. 20.

Although the present examples are described and illustrated herein as being implemented in a web-based system, the system described is provided as an example and not a limitation. As those skilled in the art will appreciate, the present examples are suitable for application in a variety of different types of computing systems.

The above examples describe the delegatee as an end user. It will be appreciated, however, that the delegatee may not be an end user in some scenarios and may, for example, be a system (e.g. an automated process).

The term ‘computer’ is used herein to refer to any device with processing capability such that it can execute instructions. Those skilled in the art will realize that such processing capabilities are incorporated into many different devices and therefore the term ‘computer’ includes PCs, servers, mobile telephones, personal digital assistants and many other devices.

The methods described herein may be performed by software in machine readable form on a tangible storage medium. The software can be suitable for execution on a parallel processor or a serial processor such that the method steps may be carried out in any suitable order, or simultaneously.

This acknowledges that software can be a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

Any range or device value given herein may be extended or altered without losing the effect sought, as will be apparent to the skilled person.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

It will be understood that the above description of a preferred embodiment is given by way of example only and that various modifications may be made by those skilled in the art. The above specification, examples and data provide a complete description of the structure and use of exemplary embodiments of the invention. Although various embodiments of the invention have been described above with a certain degree of particularity, or with reference to one or more individual embodiments, those skilled in the art could make numerous alterations to the disclosed embodiments without departing from the spirit or scope of this invention.

1. A method comprising:
downloading a piece of software code from a host, the piece of software code being associated with a user and being arranged to access a plurality of resources when executed;
verifying the piece of software code using a credential received from the user; and
executing the piece of software code locally, the execution comprising accessing the plurality of resources using at least one credential received from the user.

2. A method according to claim 1, wherein executing the piece of software locally comprises:
retrieving encrypted service credentials from a host;
decrypting the encrypted service credentials using at least one credential received from the user; and
accessing the plurality of resources using the decrypted service credentials.

3. A method according to claim 2, further comprising, prior to retrieving the encrypted service credentials from a host:
generating a parameter using a one-way function and a key; and
authenticating with the host using said parameter.

4. A method according to claim 2, wherein accessing the plurality of resources comprises:
retrieving encrypted data and an encrypted access key from each of the plurality of resources using the decrypted service credentials;
decrypting the access keys; and
decrypting the data using the access keys.

5. A method according to claim 1, wherein said host is an untrusted host.

6. A method according to claim 1, further comprising, prior to executing the piece of software locally:
decrypting the piece of software downloaded from the host using a credential received from the user.

7. A method according to claim 1, wherein the piece of software code comprises an encrypted part and an unencrypted part and wherein executing the piece of software code locally comprises:
executing the unencrypted part,
wherein said unencrypted part is arranged, on execution, to decrypt the encrypted part and execute the encrypted part, and
wherein said encrypted part is arranged, on execution, to access the plurality of resources using at least one credential received from the user.

8. A method according to claim 1, wherein verifying the piece of software code using a credential received from the user comprises one of:
verifying a signature associated with the piece of software code using a credential received from the user; and
verifying a parameter using a credential received from the user, the parameter having been generated from the piece of software code using a one-way function.

9. A method according to claim 1, further comprising:
receiving at least one credential from the user.

10. A method comprising:
storing a signed piece of software code on an untrusted host, the piece of software being arranged to access a plurality of resources when executed;
sending a message to an entity comprising credentials to enable verification of a signature associated with the piece of software code and to enable the piece of software code to access the plurality of resources when executed locally by the entity.

11. A method according to claim 10, further comprising:
generating a service credential for each of the plurality of resources for the entity; and
updating access rights for each of the plurality of resources to provide access using the service credential for each of the plurality of resources.

12. A method according to claim 11, further comprising:
encrypting the service credentials; and
storing the encrypted service credentials on a host,
and wherein said credential to enable the piece of software to access the plurality of resources when executed locally by the entity comprises a credential to enable decryption of the encrypted service credentials.

13. A method according to claim 12, further comprising:
generating an authentication parameter for said entity using a one-way function and a secret known by the entity; and
providing the authentication parameter to said host.

14. A method according to claim 12, wherein encrypting the service credentials comprises:
generating a decryption key using a secret known by the entity; and
encrypting the service credentials such that they can be decrypted using the decryption key.

15. A method according to claim 10, further comprising:
signing the piece of software code and any associated configuration data.

16. A method according to claim 10, further comprising:
encrypting at least a part of the piece of software code and any associated configuration data,
and wherein said message further comprises credentials to enable decryption of said at least a part of the piece of software code and any associated configuration data.

17. A method according to claim 10, further comprising:
generating an access control key for a data element stored at one of the plurality of resources and required by the piece of software code;
encrypting the data element using the access control key;
encrypting the access control key; and
storing the encrypted data element and the encrypted access control key at said one of the plurality of resources.

18. A delegation system comprising:
a first computing-based device comprising software arranged to download a composite service and an associated signature from an untrusted host, verify the signature using a credential received by a first user from a user associated with the composite service and execute the composite service, and wherein the composite service comprises computer executable instructions arranged, on execution, to cause the first computing-based device to access data from a plurality of sources using at least one credential received by said first user from said user associated with the composite service.

19. A delegation system according to claim 18, further comprising:
a second computing-based device comprising software arranged to store said composite service and said associated signature on said untrusted host, to generate an encrypted service credential for each of said plurality of sources, to store said encrypted service credentials in a credential store and to send credentials to said first user to enable verification of said composite service and decryption of said service credentials.

20. A delegation system according to claim 19, wherein said second computing-based device further comprises software arranged to update access rights for each of the plurality of sources to enable access using the service credential for each of the plurality of sources.
